(19) United States
(12) Patent Application Publication
(10) Pub. No.: US 2004/0103178 A1
(43) Pub. Date: May 27, 2004

(54) Information handling system and method for multilevel command implementation

(75) Inventor: James Patrick Michael O'Hara, Austin, TX (US)

Correspondence Address: Michael A. Hawes, Baker Botts L.L.P., One Shell Plaza, 910 Louisiana Street, Houston, TX, 77002-4995, US

(73) Assignee: Dell Products L.P.

(21) Appl. No.: 10/303,300

(22) Filed: Nov. 25, 2002

(51) Int. Cl. G06F 9/00; G06F 15/173

(52) U.S. Cl. 709/223

(57) ABSTRACT

An information handling system and method of multilevel command implementation are disclosed. The method parses a first command in an information handling system by inputting the first command. A function that corresponds to the first command is called. A first table identified in the function is accessed. A second table identified in the first table is accessed. A second command identified in the first table is output with a parameter identified in the second table.

### TECHNICAL FIELD

The present disclosure relates generally to the field of information handling systems and, more particularly, to an information handling system and method for multilevel command implementation.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems can include subsystems that monitor the physical health characteristics of system components, such as temperature, voltage, fans, power supplies, and chassis intrusion. Subsystems can also store system level administration information such as the warrantee information for a system or the date it was purchased. Subsystems can also store enclosure level administration information such as the number of memory slots available and the number of memory slots currently being used. Such subsystems can also monitor hardware-detected faults in the operation of system components. Conventional monitoring subsystems can be configured by specific commands that set variables associated with the operation of those subcomponents.

Conventionally, commands are organized into categories and subcategories depending on the type of output the command generates. For example, at one level commands can be segregated into commands invoking help features, commands requesting a report of system or enclosure information, and commands that modify administration parameters. Within each category, sometimes called modules, further delineation can occur based on the particular portion of the system or enclosure to which the command relates. Each command is associated with a multi-level structure of categorization. In conventional systems, commands are parsed by a separate program depending upon the module with which the command is associated.

### SUMMARY

In accordance with the present disclosure, an information handling system is disclosed. The information handling system includes a command interface agent. A command interface agent stores execution information for a plurality of functions. Each function corresponds to one or more input commands. Each function also identifies at least one table of a first type. Each table of the first type stores one or more output commands and identifies at least table of a second type that stores at least one parameter that corresponds to an output command of that table of the first type.

In another implementation of the present disclosure, a method of multilevel command implementation is disclosed. The method parses a first command in an information handling system by inputting the first command. A function that corresponds to the first command is called. A first table identified in the function is accessed. A second table identified in the first table is accessed. A second command identified in the first table is output with a parameter identified in the second table.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of a information handling system in accordance with one implementation of the present invention;

FIG. 2 is a functional block diagram of a information handling system in accordance with one implementation of the present invention; and

FIG. 3 is a flow diagram of a method for implementing multilevel commands.

### DETAILED DESCRIPTION

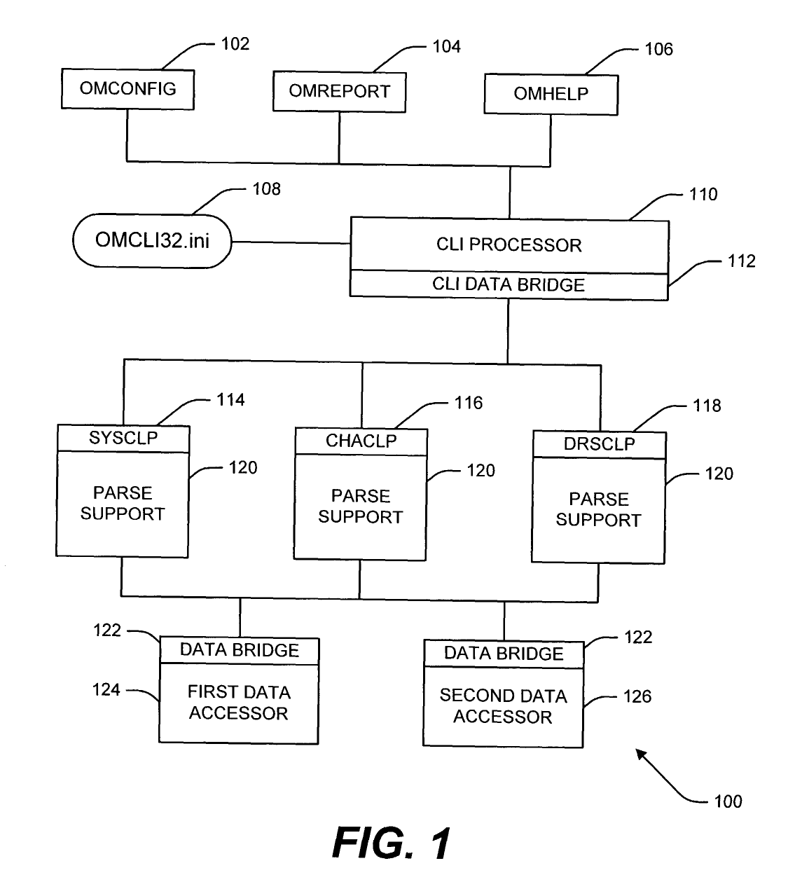

The present disclosure concerns an information handling system and method for multilevel command implementation. FIG. 1 depicts an information handling system in accordance with one implementation of the present invention. In one implementation the interface for receiving commands is a command line interface (CLI). In this implementation, parsing of CLI commands takes place at two levels. At the first level the command is classified as corresponding to a CLI plugin. That plugin then handles the command by calling a function corresponding to the command. At the second level the plugin processes pairs of names and values, referred to herein as name=value pairs. For example, for a memory mode command redundancy=mirror is a name=value pair. The name=value pairs are one type of parameter that can be included with a command. The second level determines commands that can be relayed to one of the data accessors 124, 126 and the parameters for those commands. This implementation provides a table driven mechanism, or parser, that processes commands at the second level so that the commands can be implemented. The parser receives name=value pairs that were part of the command received by the CLI and generates name=value pairs appropriate for the data accessor.

In one implementation, the name=values pairs are different for the CLI as compared to the data accessor. The CLI pairs are designed to be human readable, while the data accessor pairs are designed for maximum functionality without consideration of readability. The pairs don't have to be ordered for a given implementation of the parser and a different number of pairs may be output to the data accessor compared to the number that are received from the CLI. For example, a CLI command with several name=value pairs may not result in a single name=value pair being transmitted to the data accessor. In one implementation, help commands are implemented by displaying help text to the user rather than sending commands with parameters to the data accessor. Each defined name can specify the format for associated values. The parser can perform syntax checks to make sure that the value of each name=value pair is in the format specified by the corresponding name. Formats can include string, percentage, limited length string, date, integer, numbers with particular decimal point positions, and one of a predetermined group of strings, among others. For example, the memory mode command name redundancy specifies a value format of one of three predetermined strings: disabled, spare, and mirror. If a syntax check fails, an error message can be generated for display to the user. The data for such an error message can be transmitted from the parser in extensible Markup Language (XML).

The parser can, in some implementations, perform further checks on the validity of the CLI command. In addition to checking whether a particular value is correctly specified for a name=value pair, the parser can also evaluate whether the pairs specified are correct for the command. For example, a particular command may require that a name=value pair be included. In that case the absence of that pair can initiate the generation of an error message. Conversely, a particular command may not allow a particular name=value pair. An error could then result if the barred name=value pair is included as a parameter of the barring command. More general restrictions can also be used. A command could require that at least one of three name=value pairs be specified as a parameter with a command that includes none of the three pairs resulting in an error. The disclosed parser can be implemented in conjunction with special processing routines that handle input commands outside the command table and list table structure.

The information handling system 100 of FIG. 1 couples a CLI processor 110 to three different types of command sources: configuration commands 102, report commands 104, and help commands 106. In one implementation, the configuration commands 102 result in changes to the operating structure of the information handling system 100; the report commands 104 result in output describing the operating structure of the information handling system; and the help commands 106 result in output describing the other commands and their parameters. Each type of command can include parameters, but commands can also be allowed that do not require parameters. In one implementation, the parameters are in the form of name=value pairs. The CLI processor 110 receives input commands from one of the three interfaces. While the interface in one implementation is a Command Line Interface or CLI, other types of interfaces can also be used. For example a graphical interface could be used to specify commands and parameters.

The CLI processor 110 analyzes the command to determine the module that receives the command. The information used by the CLI processor 110 to make that determination is stored in a file that can be identified as OMCL132.ini 108. The CLI processor 110 can also extract the parameters, if any, included in the input command from the command name. In another implementation, the parameter extraction can occur at the module level. The modules illustrated in FIG. 1 show one particular implementation of the disclosed information handling system. Some implementations may not use modules or may used a different module breakdown. One breakdown of modules includes a system module (SYSCLP) 114, a chassis module (CHACLP) 116, and a remote service card module (DRSCLP) 118.

In one implementation, data bridge 112 transmits the input command and parameters, whether or not extracted from the command, to the appropriate module. Each of the modules includes parse support 120. The parse support invokes a function corresponding to the input command. That function assesses a command table and the command table, in one implementation, includes data accessor commands as well as object identifications (OIDs) for system components identified in the command. The command table can also includes pointers to list tables that provide parameters for the data accessor commands contained in the command table.

In one implementation, the command table include multiple data accessor commands and the list tables indicate only a subset of those commands to be transmitted based on parameters included in the input command. For example, an input command regarding fans could correspond to one of two data accessor commands depending upon whether the name=value pair included with the input command indicates an increase or decrease in speed. The command table accessed by the function corresponding to the input command could include entries for two data accessor commands. Each entry could include a pointer to a list table. The list table would include conditional tests to be run on the name=value pair. One list table would enable its command only if the name=value pair indicated an increase in speed while the other list table would enable its command only in the case of a decrease in speed. Thus, a command table can include entries for multiple data accessor commands, even though no more than one data accessor command will ever result from the input command. Any subset of command table data accessor commands can be determined by the list tables. For example, a command table with three data accessor commands can be linked to list tables that choose two of three based on parameters such that for any allowed parameter two commands are always transmitted.

The list tables can also be structured so that they never disable the data accessor command of the associated command table entry, but instead determine the name=value pair(s) (or other type of parameters) that will be included with the data accessor command. For example, an input command regarding memory modes can specify a name=value pair as redundancy=<disabled|spare|mirror>. The data accessor command, however, is formatted to include a parameter specified as state=<1|2|3>. The list table contains data indicating this relationship between the input command parameter format and the correct format for the parameters of the output command(s) to be sent to the data accessor.

The output commands and parameters determined by the function corresponding to the input command by accessing the command and list tables are transmitted to a data accessor via a data bridge 122. In one implementation, a first data accessor 124 and a second data accessor 126 are both available to receive commands from the module parsers 120. In another implementation, only one data accessor is available. In another implementation, the output commands are transmitted to a destination other than a data accessor.

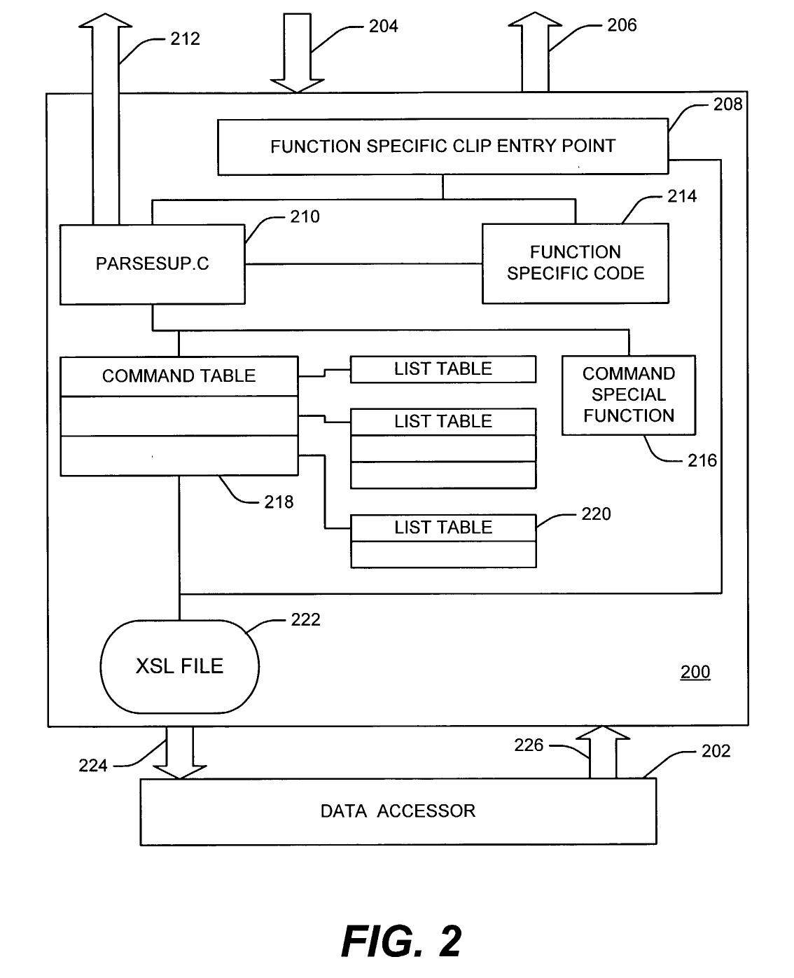

FIG. 2 shows a functional block diagram of a information handling system in accordance with one implementation of the present invention. The function 200 corresponds to a particular input command that in one implementation is received by a particular module. An interface 208 for the CLI Parser or CLIP received name=value pairs 204. Those name=value pairs are then transmitted to either function specific code 214 that supplements the table structure or to the parser code PARSEUP.C 210. The parser code 210 can generate a response to commands that don't require interaction with the data accessor 202, for example help commands and some report commands, and return that response using an XML message 212.

Information returned from the function 200 can also include formatting as well as data. The formatting can be encoded in eXtensible Stylesheet Language or XSL. Some functions will include a link to an XSL file 222 for use in providing format information. The parser code 210 accesses at least one command table 218. The command table entries link to one or more list tables 220. As discussed above, the command table 218 entries include data accessor 202 commands, possibly including require OIDs, that correspond to the input command for the function 200. The list tables 220 can include data determining conditions for transmitting a particular data accessor 202 command or determining the name=value pairs to be included with each command. The commands and parameters 224 determined from the tables are then transmitted to the data accessor 202. The data accessor 202 replies to the function 200 with data 226 that can be in the form of XML. The function combined that data 226 with formatting from the XSL file 222 as necessary and returns the resulting information 206.

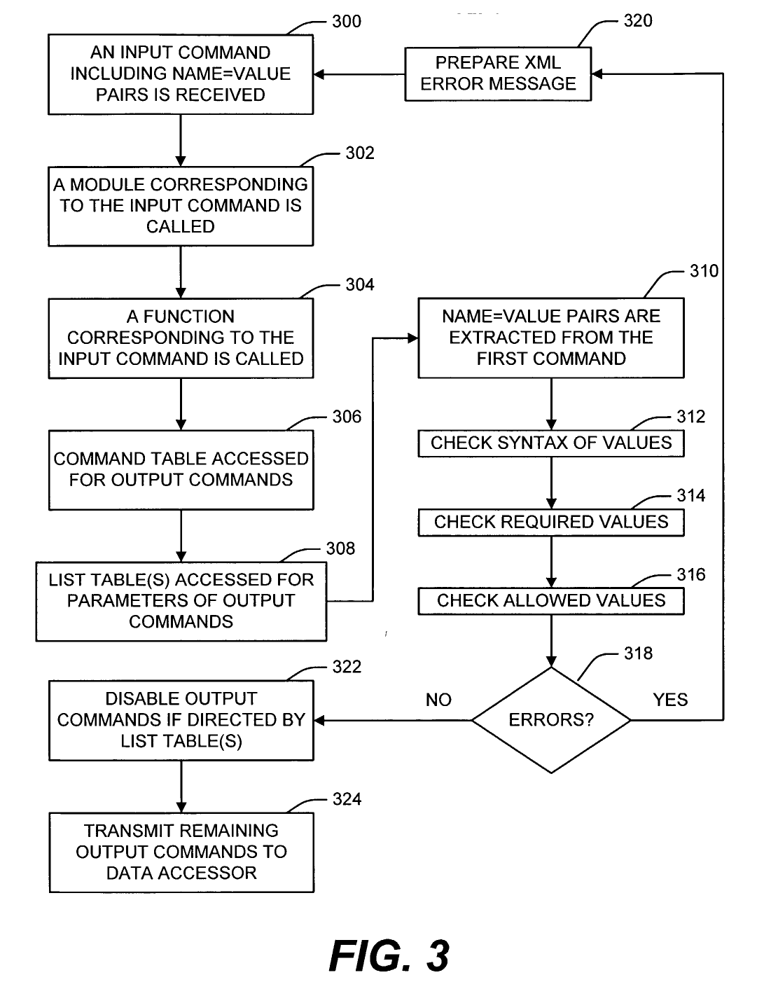

FIG. 3 is a flow diagram of a method for implementing multilevel commands. A multilevel commands is any command that can be interpreted in more than one way. For example, any command that includes parameters is a multilevel command. The method for implementing multilevel commands can be used to implement a set of commands that includes both multilevel commands and single interpretation commands. In one implementation, an input command including one or more name=value pairs is received 300. If the parsing is divided between modules, a module corresponding to the input command is called 302. A function that corresponds to the input command is then called 304. That function accesses at least one command table that include output commands 306. In one implementation, the output commands are commands suitable for a data accessor. One or more list tables are then accessed to determine parameters, including but not limited to name=value pairs, to accompany the output command(s) 308. The list tables can use parameters accompanying the input commands to determine the correct parameters to accompany the output commands.

The name=value pairs included with the input command are extracted 310. The values of the pairs are checked for syntax 312 and to see whether they are required 314 or allowed 316 values based on the names portion of the pairs. If any of the checks result in values that do not meet the requirements of the corresponding name 318, XML is generated to transmit the data required for the error message 320 and the method is ready to receive a new command 300.

If the name=value pairs do not result in an error, as discussed above, the list tables can also determine whether particular output commands will be transmitted 322. The output commands that are not disabled are then transmitted with the parameters determined by the list tables to a data accessor 324 or to another destination appropriate for a particular implementation of the parser.

In one implementation, the parser structure including the input command specific functions, command tables, and list tables are defined using the C programming language. The information specific to a particular command is then contained in a C file related to the specific command. The use of tables can reduce development time by eliminating rewriting of similar code. New functions can be created or modified by adding new tables entries or modifying existing entries in the command or list tables. In other implementations, a different programming language can be used.

For purposes of this disclosure, a table is a data structure with one or more similarly formatted records. A table includes, but is not limited to, an array in which each element is a record containing multiple data items, a linked list of records, or several arrays of different data types using a common indexing scheme. A table also includes, but is not limited to, any collection of data that is arranged in rows and columns.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Although the present disclosure has been described in detail, it should be understood that various changes, substitutions, and alterations can be made hereto without departing from the spirit and the scope of the invention as defined by the appended claims. For example, the invention can be used to maintain drives other than quorum drives in a cluster.

What is claimed is:

1. A method of parsing a first command in an information handling system, comprising the steps of:
(a) inputting the first command;
(b) calling a function corresponding to the first command;
(c) access a first table identified in the function; and
(d) accessing a second table identified in the first table; and
(e) outputting a second command identified in the first table with a parameter identified in the second table.

2. The method of claim 1 wherein the first command includes one or more name=value pairs.

3. The method of claim 1 wherein the second command includes one or more name=value pairs.

4. The method of claim 1 wherein the first command and second command are different commands.

5. The method of claim 1 wherein the step of calling a function corresponding to the first command includes checking the first command for required parameters.

6. The method of claim 1 wherein the step of calling a function corresponding to the first command includes checking the first command for allowed parameters.

7. The method of claim 1 further comprising:
(f) outputting a third command identified in the first table with a parameter identified in the second table.

8. The method of claim 1 wherein the second table is identified in the first table with a pointer.

9. The method of claim 1 further comprising.
(f) receiving the second command at a data accessor that initiates a program corresponding to the second command.

10. The method of claim 1 wherein the first table identifies the second command and a third command and the second table includes parameters that block outputting of the third command based on a parameter of the first command.

11. An information handling system, comprising:
a command interface agent,
a plurality of functions each corresponding to one or more input commands, the command interface agent storing execution information for the functions,
a plurality of first type tables each storing one or more output commands, each function identifying at least one first type table, and
a plurality of second type tables each storing at least one parameter, each first type table identifying at least one second type table storing at least one parameter corresponding to the one or more output commands stored in that first type table.

12. The information handling system of claim 11, wherein the input commands include one or more name=value pairs.

13. The information handling system of claim 11, wherein the output commands include one or more name=value pairs.

14. The information handling system of claim 11, wherein input commands are different than the output commands.

15. The information handling system of claim 11, wherein each of the plurality of functions includes a required parameter agent that stores required parameters.

16. The information handling system of claim 11, wherein each of the plurality of functions includes a limited parameter agent that stores allowed parameter values.

17. The information handling system of claim 11, wherein a function corresponds to one input command and identifies a first type table storing a plurality of output commands.

18. The information handling system of claim 11, wherein the first type tables include pointers to the locations of second type tables.

19. The information handling system of claim 11, further comprising a data accessor coupled to the command interface agent and wherein the data accessor stores programs corresponding to the output commands.

20. The information handling system of claim 11, wherein the function corresponding to an input command identifies a first type table that includes at least two output commands, the first type table identifies one or more second type tables, the one or more second type tables include parameters that disable one of the at least two output commands based on a parameter of the input command.
